(19) United States
(12) Patent Application Publication
(10) Pub. No.: US 2009/0286995 A1
(43) Pub. Date: Nov. 19, 2009

(54) METHOD FOR THE PRODUCTION OF BORONIC ACIDS CARRYING CYANOALKYL, CARBOXYL AND AMINOCARBONYL GROUPS AND THEIR DERIVATIVES

(76) Inventors: Andreas Meudt, Hofheim (DE); Sven Nerdinger, Kiefersfelden (DE); Bernd Wilhelm Lehnemann, Cologne (DE)

Correspondence Address: PROPAT, L.L.C., 425-C SOUTH SHARON AMITY ROAD, CHARLOTTE, NC, 28211-2841, US

(21) Appl. No.: 12/296,292

(22) PCT Filed: Mar. 1, 2007
(86) PCT No.: PCT/EP07/01764

§ 371 Date: Oct. 7, 2008

(30) Foreign Application Priority Data
Apr. 21, 2006 (DE) 102006018524.2

(51) Int. Cl. C07F 5/02

(52) U.S. Cl. 549/4; 562/7

(57) ABSTRACT

A process for the manufacture of aminocarbonyl boronic acids of formula (IV) by converting the compounds of formula (III) with a Brønsted base Y(OH)ₙ in a solvent or a solvent mixture, in which Z represents an optionally substituted arylene, heteroarylene, alkene, heteroalkene, alkylidene, heteroalkylidene, alkenylidene, heteroalkenylidene, alkynylidene, arylalkylene, heteroarylalkylene, arylheteroalkylene, heteroarylheteroalkylene, alkylheteroarylene, heteroalkylheteroarylene, or alkylarylene group; Y represents a metal or ammonium cation of valence n with 0<n<5; and B represents boronic acid, boronic acid ester, or a borate, or a boronic acid anhydride. The aminocarbonyl boronic acids of formula (IV) can be further hydrolyzed to form the carboxy boronic acid of formula (V).

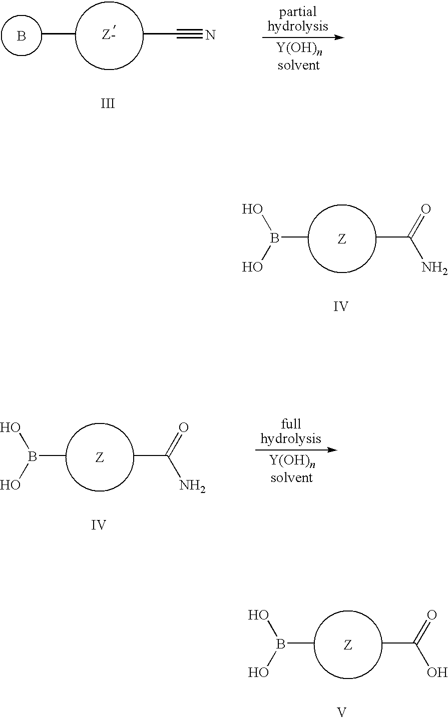

The invention relates to a process for preparing boronic acids which bear a cyano, carboxyl or aminocarbonyl group at any position, and the esters and salts thereof. In this process, an organic compound bearing at least one nitrile group is metalated (for example by halogen-metal exchange or deprotonation) and then converted with a trialkyl borate to the corresponding boronic acid or a boronic acid derivative, which is then optionally converted while maintaining the boronic acid functionality, by partial hydrolysis to an aminocarbonyl group or by full hydrolysis to a carboxyl group.

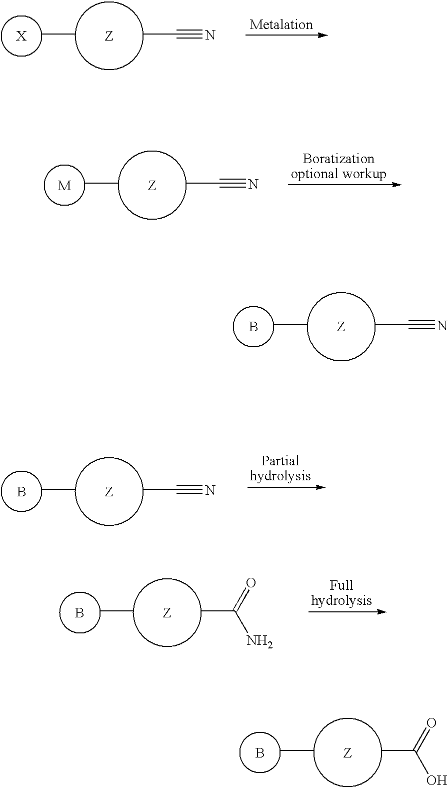

The growth in transition metal-catalyzed C—C couplings in the pharmaceutical and agrochemical sector in particular is being accompanied by a rising demand for aryl- and heteroarylboronic acids, whose substitution patterns are becoming ever more complex. Especially nitrites, amides and carboxylates are functional groups which occur very frequently in biologically active molecules or chemical precursors thereof. In contrast, barely any boronic acids functionalized with these groups are available from chemical suppliers; more particularly, N-unsubstituted aminocarbonylboronic acids are obtainable only in small amounts and at such high costs that use outside active substance research appears to be scarcely viable. In spite of their great significance for biologically active substance classes, such heterocyclic boronic acids and alkylboronic acids in particular are virtually completely unavailable. For boronic acids bearing nitrile functions, some syntheses have been published in recent times; for example, arylboronic acids derived from benzonitriles are obtainable by metalating bromo- or iodobenzonitriles and reacting the metalated intermediates—optionally in situ—with trialkyl borates (e.g. Li et al., J. Org. Chem. 2002, 67, 15, 5394).

A general route consists in the transition metal-catalyzed coupling of halides with pinacolborane (e.g. Giroux, Tetrahedron Lett. 2003, 44, 2-6, 233) or bis(pinacolato)diboron (e.g. Mewshaw et al., J. Med. Chem. 2005, 12, 3953); however, owing to the exceptionally high cost of these reagents, these methods are at present only of minor interest in economic terms.

It would be desirable to have an economically viable, efficient process in order also to be able to functionalize nonaromatic nitrites with boronic acid groups.

The conventional route to the preparation of carboxyarylboronic acids consists in the side chain oxidation of methylarylboronic acids by means of potassium permanganate (Fry et al., J. Org. Chem. 1973, 38, 4016; Koenig et al., J. Prakt. Chem. 1930, 153, Tao et al., Synthesis 2002, 8, 1043). There are also isolated descriptions of the oxidation of formyl groups with this reagent (Filippis et al., Synth. Commun. 2002, 17, 2669). Other oxidizing agents are unsuitable, since they destroy the boron function. The strong oxidizing agent potassium permanganate has several serious disadvantages. One is that it is incompatible with many functional groups; even higher alkyl groups are attacked under the reaction conditions. It is thus scarcely possible to prepare relatively highly functionalized carboxyarylboronic acids. Especially in the case of heteroarylboronic acids, there is frequently the additional risk of oxidation of the heteroatom, for example in pyridines or thiophenes, such that carboxyarylboronic acids derived from these systems are unobtainable by this route. Equally unobtainable by this route are alkylboronic acids, since there is generally overoxidation, i.e. decomposition with carbon dioxide formation. A further disadvantage of potassium permanganate which becomes serious in the case of preparation on a larger scale is the occurrence of a large amount of manganese oxide as a waste product, which has to be isolated and disposed of as hazardous waste in the correct manner.

For the reasons mentioned above, it would therefore be desirable to provide a process for introducing the carboxyl function into boronic acids which does not need oxidative conditions.

Aminocarbonylboronic acids are obtainable on the chemicals market only in small amounts. While derivatives derived from tertiary amides and also some derived from secondary amides are preparable by introducing the boronic acid function via organometallic intermediates (for example ortho-metalation or halogen-metal exchange, for example Liao et al., J. Med. Chem. 2000, 43, 517), primary amides are obtainable by this route only via complicated protecting group operations. The reverse route—where the aminocarbonyl function is formed in the presence of the boronic acid function—is even more complicated; usually, a carboxyphenylboronic acid is first protected on the boron function, then activated on the carboxyl function and finally reacted with the appropriate amine, before the protecting group is removed again (e.g. Hall et al., Agnew. Chem. 1999, 111, 3250; Angew. Chem. Int. Ed. 1999, 38, 3064).

It would be desirable to have a more efficient process which enables a route especially to primary aminocarbonylboronic acids without the need for protecting group operations.

Alkylboronic acids substituted by cyano, carboxyl or aminocarbonyl groups are likewise scarcely obtainable; no general route to these compound classes has been described.

In contrast to carboxyl, aminocarbonyl and ester functionalities, the nitrile function is compatible under suitable conditions with the organometallic compounds typically used for boronic acid synthesis (Li et al., J. Org. Chem. 2002, 67, 15, 5394), and so cyanoboronic acids are obtainable significantly more easily than other carboxylic acid derivatives. Moreover, there exist further methods for introducing the nitrile function which are compatible with boronic acids or boronic esters or boronic anhydrides, for example the Finkelstein exchange of halogens for cyanide (e.g. Miginiac et al., J. Organomet. Chem. 1971, 29, 349) or the mild dehydration of aldehyde oximes (Meudt et al., WO 2005/123661).

The present invention solves all three problems and relates to a process for preparing aminocarbonylboronic acids of the formula (IV) by reacting compounds of the formula (III) with a Brønsted base Y(OH)ₙ in a solvent or solvent mixture

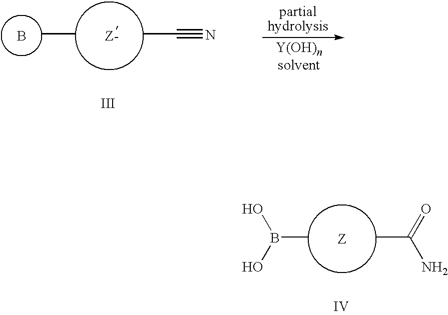

where X is an optionally substituted organic diradical structure, e.g. arylene, heteroarylene, alkylene, heteroalkylene, alkylidene, heteroalkylidene, alkenylidene, heteroalkenylidene, alkynylidene, arylalkylene, heteroarylalkylene, arylheteroalkylene, heteroarylheteroalkylene, alkylheteroarylene, hetero-alkylheteroarylene or alkylarylene radical,

Y is a cation of valency n and

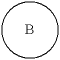

is a boronic acid, a boronic ester or a borate, or a boronic anhydride.

Z may bear any substituents, for example hydrogen, methyl, primary, secondary or tertiary, cyclic or acyclic alkyl radicals having from 2 to 12 carbon atoms, in which one or more hydrogen atoms are optionally replaced by fluorine or chlorine, e.g. CF₃, substituted cyclic or acyclic alkyl groups, hydroxyl, alkoxy, dialkylamino, alkylamino, arylamino, diarylamino, amino, phenyl, substituted phenyl, heteroaryl, substituted heteroaryl, thio, alkylthio, arylthio, diarylphosphino, dialkylphosphino, alkylaryl-phosphino, CO₂⁻, hydroxyalkyl, alkoxyalkyl, fluorine, chlorine, bromine, iodine, nitro, aryl or alkyl sulfone, aryl- or alkylsulfonyl, formyl, alkylcarbonyl, (hetero)arylcarbonyl, and if appropriate also aminocarbonyl, dialkyl-, arylalkyl- or diarylamino-carbonyl, monoalkyl- or monoarylaminocarbonyl, alkyl- or aryloxycarbonyl.

The Brønsted base used for the hydrolysis is Y(OH)ₙ. Y may be a metal of valency n where 0<n<5, or else an aliphatic or aromatic ammonium cation. Preference is given to the inexpensive and strong bases of the alkali metals and of the alkaline earth metals.

Particular preference is given to lithium hydroxide, sodium hydroxide, potassium hydroxide, rubidium hydroxide, cesium hydroxide, calcium hydroxide, strontium hydroxide and barium hydroxide.

At least 2 equivalents of hydroxide anions are required in order to achieve full hydrolysis of the cyano function to a carboxyl function in anhydrous media (see below), and at least 1 equivalent based on the compound of the formula (III) in order to achieve full conversion of the cyano function to the aminocarbonyl function. In aqueous media, 1 equivalent is typically sufficient. In addition, a portion of the base is bound reversibly by virtue of the boronic acid used or ester thereof being quaternized by addition of a hydroxide ion. It has been found that a full equivalent of hydroxide ions is not required for this purpose, but rather a substoichiometric amount, for example from 0.25 to 0.95 equivalent based on the compound of the formula (III), is entirely sufficient. In the case of use of a borate salt which may have been prepared in situ, there is no need at all for quaternization. The reaction is therefore carried out preferably with from 1 to 10 equivalents of hydroxide. Particular preference is given to performance with 1-4 equivalents.

When further acidic radicals or radicals which bind hydroxyl ions in another way are present in the substrate, the number of equivalents of hydroxide ions required for complete reaction increases correspondingly.

It is equally possible to generate the Brønsted base Y(OH)ₙ in situ, for example by using other bases, for example carbonates, fluorides or amines, or basic oxides in aqueous media.

Such preferred Brønsted bases are sodium carbonate, potassium carbonate, cesium carbonate, potassium phosphate, magnesium hydroxide, aliphatic or aromatic amines or ammonia, provided that they are used in conjunction with water.

The hydrolysis reaction is preferably carried out in a solvent or solvent mixture. Suitable solvents are in particular polar aprotic and protic solvents and mixtures thereof in which both the substrate and the base are sufficiently soluble at the reaction temperature in order to ensure a rapid reaction, but which themselves take part in the reaction only to a limited degree, if at all.

Preference is given to using water, linear, branched or cyclic (C₁-C₂₀)-alkyl alcohols, linear, branched or cyclic (C₁-C₂₀)-alkanediols, linear, branched or cyclic (C₁-C₂₀)-alkanetriols, DMPU (dimethylpropylideneurea), NMP (N-methylpyrrolidone), DMF (dimethylformamide), DMAc (dimethylacetamide), tetrahydrofuran, 2-methyl-tetrahydrofuran, glymes or PEG (polyethylene glycol), or a mixture of a plurality of these solvents.

Particular preference is given to tetrahydrofuran, 2-methyltetrahydrofuran, water, methanol, ethanol, 1-propanol, 2-propanol, 1-butanol, 1-pentanol, tert-butanol, ethylene glycol, propylene glycol, glycerol, butylene glycol, di-, tri- and tetraethylene glycol, and also polyethylene glycols and mixtures thereof.

The reaction temperature of the hydrolysis is preferably selected such that the reaction proceeds at an acceptable rate and with the desired selectivity. Generally, reaction temperatures between room temperature and 250° C. can be employed, preference being given to temperatures between 65 and 200° C., particular preference to the standard pressure boiling point of the solvent or solvent mixture used.

For practical purposes, the concentration of the reactants is selected such that a very saturated solution in the selected solvent or solvent mixture is present at reaction temperature; however, the reaction can also be carried out in suspension or in relatively high dilution.

The preferred workup variant is the hydrolysis of the reaction mixture, followed by precipitation of the resulting boronic acid by establishing the appropriate pH with a Brønsted acid and isolating by filtration or centrifugation. Other means of workup include the isolation of the product as a borate salt or boronic ester, and also the in situ reaction of the resulting basic product solution with further reagents, for example in situ alkylation to obtain carboxylic esters or N-alkylaminocarbonylboronic esters.

In a preferred embodiment, the aminocarbonylboronic acid of the formula (IV) formed is hydrolyzed further to the carboxyboronic acid of the formula (V).

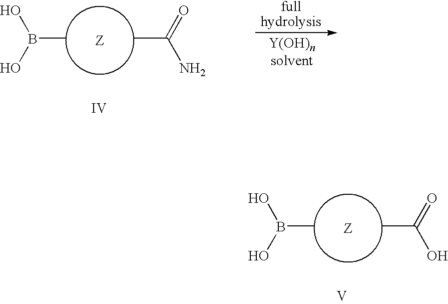

This is accomplished by further hydrolyzing the compound of the formula (IV) at higher temperatures, preferably in the range from 90 to 200° C., and/or optionally longer heating, up to 60 hours, using a suitable amount of the base Y(OH)ₙ i.e. more than 1 equivalent of hydroxide ions based on (III) in aqueous media and more than 2 equivalents based on (III) in nonaqueous media.

In general, the hydrolysis of the nitrile group to the carboxamide is accomplished significantly more easily than the hydrolysis of the amide to the free carboxylic acid, such that a good selectivity of the hydrolysis between aminocarbonyl- and carboxyboronic acid is achieved.

The present invention further relates to a process for preparing boronic acids of the formula (III) functionalized by cyano groups by metalating nitrile compounds of the formula (I) with a metalating reagent MR and then reacting the metalated compound of the formula (II) with a trialkyl borate to give the compound of the formula (III).

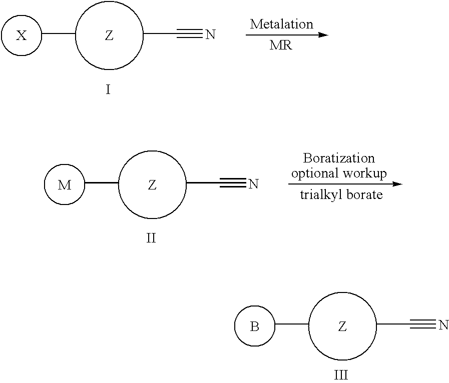

where X is H, Br or I,
MR is a metalating reagent

### and Z and

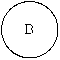

are each as defined above.

In the case of boronic esters, they may be optionally mixed esters of simple alcohols such as methanol, ethanol, 1-propanol, isopropanol, etc., polyhydric alcohols such as ethylene glycol, propylene glycol, butylene glycol, pinacol, neopentyl glycol, etc., or else amino alcohols such as N-methyl- or N-phenyldiethanolamine. When borates are used, these radicals may likewise be present, and also the hydroxide ion, optionally in mixed form. Usually, they are (cyanoorganyl)trimethyl borates and (cyanoorganyl)-triisopropyl borates prepared in situ.

The CN radical is preferably bonded to an aliphatic group.

The compound of the formula (III) is preferably obtained in situ from the compound of the formula (I) by metalation and subsequent reaction with a trialkyl borate.

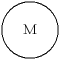

is a metal, if appropriate with further counterions and/or ligands, preferably an alkali metal or alkaline earth metal or zinc, more preferably lithium, magnesium and zinc.

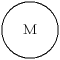

is introduced by the metalating reagent MR. MR may be alkyl-, vinyl- and aryllithium compounds, and also Grignard and diorganomagnesium compounds, and also triorganyl magnesates and metallic zinc, and also organozinc compounds, and additionally optionally organically substituted alkali metal and alkaline earth metal amides and silazides, and in some cases also alkoxides. MR may additionally include auxiliaries which facilitate or accelerate the metalation, for example lithium chloride or TMEDA.

Preference is given to performing the metalation with a metalating reagent from the following group: lithium organyls, lithium organyls in the presence of complexing agents or alkali metal alkoxides, alkali metal amides and silazides, Grignard compounds, magnesium diorganyls, triorganyl magnesates, magnesium dialkylamides, and these reagents in the presence of alkali metal salts and/or complexing agents, metallic zinc.

An amount of metalating reagent at least sufficient for complete metalation is required. This is at least 1 equivalent in the case of alkali metal compounds, Grignard compounds and zinc, at least 0.5 equivalent in the case of dialkylmagnesium compounds and at least 0.34 equivalent in the case of triorganyl magnesates. Frequently, a full conversion requires the use of metalating agent in excess. When acidic functions against which the metalating agent acts as a base are present in the molecule, an appropriate excess of the metalating agent has to be used.

For boratization, it is possible to use any boric triesters, for example trialkyl borates, triaryl borates, mixed alkyl aryl borates or mixed boric esters of mono- and polyhydric alcohols, for example isopropyl pinacol borate or cyclohexyl pinacol borate. The boratizing reagent can be added before the metalation in order to achieve in situ scavenging of the metalated compound (II), or be reacted with (II) on completion of metalation.

An amount of boric triester at least sufficient to achieve full conversion of the metalated cyano compound to the boronic acid derivative (III) is used, i.e. at least 1 equivalent. Frequently, it is necessary to work with excess and boric triesters in order to achieve full conversion, or to destroy metalating agent present in excess by boratization.

The reaction temperature of the metalation and boratization is preferably selected such that the reaction proceeds with high selectivity and acceptable rate without side reactions occurring. Generally, the metalation is preferably carried out between −120 and +50° C., in the case that MR=alkali metal organyl more preferably between −100 and −30° C., in the case that MR=alkaline earth metal organyl or zinc more preferably between −40 and +30° C. The boratization itself is preferably carried out between −120 and +20° C., especially at from −100 to 0° C.

The preparation of the boronic acid of the formula (III) is preferably carried out in a solvent or solvent mixture. Suitable solvents are in particular open-chain and cyclic ethers, and also aromatic and aliphatic hydrocarbons, especially tetrahydrofuran, 2-methyl-tetrahydrofuran, diisopropyl ether, methyl tert-butyl ether, dibutyl ether, toluene, xylenes, hexane, heptane, isohexane or similar solvents, and mixtures thereof.

Preferred compounds of the formula (I) which can be converted to boronic acid by the process according to the invention are, for example, haloalkyl nitriles, haloalkylaryl nitriles, haloalkylheteroaryl nitriles, haloalkylvinyl nitrites, haloalkylalkynyl nitriles (by halogen-metal exchange), alkynyl nitrites, alkynylalkyl, -aryl, -heteroaryl nitrites (by deprotonation), which may optionally be substituted by further functional groups.

Preferred compounds of the formula (III) which can be hydrolyzed by the process according to the invention are, as well as the cyanoalkyl-, -vinyl- and -alkynyl-substituted boronic acids derived from the formula (I), also, for example, cyanophenylboronic acids, cyano-pyridinyl-, -pyrimidinyl-, -pyrazinyl-, -pyridazinyl-, -furanyl-, -thiophenyl-, -pyrrolyl-, -naphthyl-, -biphenyl- and -quinolinylboronic acids, and also cyanoalkylaryl- and cyanoheteroalkylarylboronic acids, and also cyanovinyl- and cyanoalkynylboronic acids.

More particularly, representatives of the compounds of the formula (III) are the following compounds, without restricting them thereto:

| | |
|---|---|
| where Z = arylene | 3-cyanophenylboronic acid |
| where Z = heteroarylene | 3-cyanopyridine-4-boronic |
| | acid |
| where Z = alkylene | 5-cyanopentane-1-boronic |
| | acid |
| where Z = heteroalkylene | 3-(3-cyanopropoxy)propane- |
| | 1-boronic acid |
| where Z = alkylidene | 6-cyanohex-1-ene-1-boronic |
| | acid, 6-cyanohex-5-ene- |
| | 1-boronic acid |
| where Z = heteroalkylidene | 3-methoxycyclohex-1-ene- |
| | 1-boronic acid |
| where Z = alkynylene | 6-cyanohex-1-yne-1-boronic |
| (instead of alkynylidene) | acid |
| where Z = arylalkylene | 2-(3-cyanophenyl)ethane- |
| | boronic acid |
| where Z = heteroaryl- | 2-(3-cyanopyrid-4-yl)- |
| alkylene | propaneboronic acid |
| where Z = arylhetero- | 6-(3-cyanophenyl)-3-oxa- |
| alkylene | hexane-1-boronic acid |
| where Z = heteroarylhetero- | 6-(3-cyanopyrid-4-yl)- |
| alkylene | 3-oxahexane-1-boronic acid |
| where Z = alkylhetero- | 4-(2-cyanoethyl)pyridyl- |
| arylene | 3-boronic acid |
| where Z = heteroalkyl- | 4-(6-cyano-3-oxahexyl)- |
| heteroarylene | pyridyl-3-boronic acid |
| where Z = alkylarylene | 4-(2-cyanoethyl)phenyl- |
| | boronic acid |

The reaction mixture of the boratization is worked up in a customary manner, at least by hydrolysis with subsequent precipitation of the boronic acid. The hydrolysis mixture can also be transferred directly into the hydrolysis stage of the nitrile function and be processed further without isolating the boronic acid.

The process according to the invention for preparing the compounds of the formulae (III), (IV) and (V) thus offers an inexpensive and environmentally friendly route to cyanoboronic acid, carboxyboronic acids and aminocarbonylboronic acids and derivatives thereof. Moreover, it offers a considerable economic advantage over known processes. Many structural variations only become economically realizable with this process.

The process according to the invention will be illustrated by the examples which follow, without being restricted thereto:

### 1. Preparation of 3-carboxyphenylboronic acid

10 g (68 mmol) of 3-cyanophenylboronic acid and 15.26 g (272 mmol, 4 eq.) of potassium hydroxide powder were suspended in 40 ml of ethylene glycol and heated to 175° C. After three hours, the reaction mixture was allowed to cool and was diluted with 60 ml of water. The pH was adjusted to 2-3 with 32% hydrochloric acid, which precipitated the 3-carboxyphenylboronic acid in colorless crystalline form, which was isolated by filtering it off with suction. The crystals were washed with water and dried under a gentle vacuum at 35° C. The yield was 10.04 g (60.5 mmol, 89%).

### 2. Preparation of 4-carboxyphenylboronic acid

4-Cyanophenylboronic acid was converted analogously to Example 1. The yield was 10.16 g (61.2 mmol, 90%).

### 3. Preparation of 2-carboxyphenylboronic acid

2-Cyanophenylboronic acid was converted analogously to Example 1. The yield was 8.46 g (51.0 mmol, 75%).

### 4. Preparation of 3-aminocarbonylphenylboronic acid

10 g (68 mmol) of 3-cyanophenylboronic acid and 11.45 g (204 mmol, 3 eq.) of potassium hydroxide powder were suspended in 40 ml of methanol and heated to reflux until monitoring of the conversion by HPLC indicated full conversion of the starting material. The reaction mixture was allowed to cool and was diluted with 60 ml of water. The pH was adjusted to 5-6 with 10% hydrochloric acid, which precipitated the 3-carboxy-phenylboronic acid in the form of pale violet crystals, which were isolated by filtering them off with suction. After recrystallization from a little toluene and drying under gentle vacuum at 35° C., the yield was 7.74 g (46.9 mmol, 69%).

### 5. Preparation of 4-aminocarbonylphenylboronic acid

4-Cyanophenylboronic acid was converted analogously to Example 4. The yield was 8.30 g (50.3 mmol, 74%).

### 6. Preparation of 2-aminocarbonylphenylboronic acid

2-Cyanophenylboronic acid was converted analogously to Example 4. The yield was 5.83 g (35.4 mmol, 52%).

### 7. Preparation of 3-(carboxymethyl)phenylboronic acid

5 g (31.1 mmol) of 3-(cyanomethylphenyl)boronic acid and 5.23 g (93.3 mmol, 3 eq.) of potassium hydroxide were suspended in 20 ml of ethylene glycol and 2 ml of water and heated to 155° C. with stirring. After 18 h, the mixture was allowed to cool, and was diluted with 20 ml of 10% sulfuric acid and extracted twice with 20 ml each time of dichloromethane. The combined organic phases were concentrated and the residue was recrystallized from heptane. 4.31 g (23.95 mmol, 77%) of the product were obtained as a pale yellow solid.

### 8. Preparation of 3-(aminocarbonylmethyl)phenyl-boronic acid

5 g (31.1 mmol) of 3-(cyanomethylphenyl)boronic acid and 9.33 g (62.2 mmol, 2 eq.) of cesium hydroxide were suspended in 20 ml of ethylene glycol and 2 ml of water and heated to 70° C. with stirring. Once monitoring of the conversion by HPLC indicated full conversion, the mixture was allowed to cool and was diluted with 20 ml of water, the pH was adjusted to 5-6 with 10% sulfuric acid, the mixture was extracted twice with 20 ml each time of dichloromethane and the combined dichloro-methane phases were concentrated. The residue was recrystallized from heptane. 3.67 g (20.53 mmol, 66%) of the product were obtained as a yellowish solid.

### 9. Preparation of 5-carboxypentylboronic acid

2.53 g (10 mmol) of dibutyl 5-cyanopentylboronate and 2.24 g (40 mmol, 4 eq.) of potassium hydroxide were boiled at reflux in 20 ml of water overnight. After cooling, the reaction mixture was neutralized with 10% sulfuric acid and the aqueous residue was extracted continuously with dichloromethane for 48 h. After the dichloromethane solution had been concentrated, the product was obtained as a yellow oil (0.75 g, 4.7 mmol, 47%).

### 10. Preparation of 5-aminocarbonylpentylboronic acid

2.53 g (10 mmol) of dibutyl 5-cyanopentylboronate and 1.12 g (20 mmol, 2 eq.) of potassium hydroxide were boiled at 45° C. in 20 ml of water until the monitoring of conversion by HPLC indicated optimal conversion to the target compound. After cooling, the reaction mixture was neutralized with 10% sulfuric acid and the aqueous residue was extracted continuously with dichloromethane for 48 h. After the dichloromethane solution had been concentrated, the product was obtained as a yellow oil (0.81 g, 5.1 mmol, 51%).

### 11 Preparation of 2-carboxythiophene-5-boronic acid

1.53 g of 2-cyanothiophene-5-boronic acid (10 mmol) and 1.68 g (30 mmol, 3 eq.) of potassium hydroxide were suspended in 15 ml of methanol and heated to reflux for 6 h. The mixture was allowed to cool, the pH was adjusted to 5-6 with 10% hydrochloric acid, the reaction mixture was extracted twice with 25 ml of dichloromethane and the combined organic phases were concentrated. 1.34 g (7.8 mmol, 78%) of the product were obtained as a yellow oil which crystallized in a refrigerator.

### 12. Preparation of 2-aminocarbonylthiophene-5-boronic acid

1.53 g of 2-cyanothiophene-5-boronic acid (10 mmol) and 1.12 g (20 mmol, 2 eq.) of potassium hydroxide were suspended in 15 ml of methanol and stirred at 54° C. until HPLC monitoring indicated optimal conversion to the target product. The mixture was allowed to cool, the pH was adjusted to 5-6 with 10% hydrochloric acid, the reaction mixture was extracted twice with 25 ml each time of dichloromethane and the combined organic phases were concentrated. 1.18 g (6.9 mmol, 69%) of the product were obtained as a yellow oil, which crystallized in a refrigerator.

1. A process for preparing aminocarbonylboronic acids of the formula (IV) comprising reacting compounds of the formula (III) with a Brønsted base Y(OH)ₙ in a solvent or solvent mixture 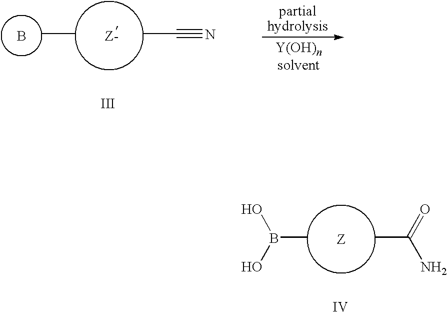
where Z is an optionally substituted arylene, heteroarylene, alkylene, heteroalkylene, alkylidene, heteroalkylidene, akenylidene, heteroalkenylidene, alkynylidene, arylalkylene, heteroarylalkylene, arylheteroalkylene, heteroarylheteroalkylene, alkylheteroarylene, heteroalkylheteroarylene or alkylarylene radical,
Y is a metal or ammonium cation of valency n where 0<n<5
and 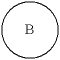
is a boronic acid, a boronic ester or a borate, or a boronic anhydride.

2. The process as claimed in claim 1, wherein the Brønsted base is selected from lithium hydroxide, sodium hydroxide, potassium hydroxide, rubidium hydroxide, cesium hydroxide, calcium hydroxide, strontium hydroxide, or barium hydroxide.

3. The process as claimed in claim 1, wherein the Brønsted base is selected from sodium carbonate, potassium carbonate, cesium carbonate, potassium phosphate, magnesium hydroxide, aliphatic or aromatic amine, or ammonia in conjunction with water.

4. The process as claimed in claim 1, wherein the solvent is water, a linear, branched, cyclic (C₁-C₂₀)-alkyl alcohol, a linear, branched or cyclic (C₁-C₂₀)-alkanediol or alkanetriol, DMPU, NMP, DMF, DMAc, tetrahydrofuran, 2-methyltetrahydrofuran, glymes, PEG or a mixture of a plurality of these solvents.

5. The process as claimed in claim 1, wherein the reaction temperature is between 20° C. and 250° C.

6. The process as claimed in claim 1, wherein the aminocarbonylboronic acid of the formula (IV) is hydrolyzed further to the carboxyboronic acid of the formula (V).

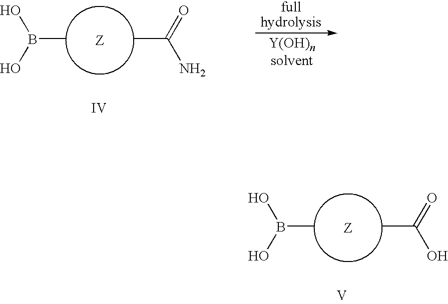

7. The process as claimed in claim 1, wherein the compound of the formula (III) is obtained from the compound of the formula (I) by metalation and subsequent reaction with a trialkyl borate 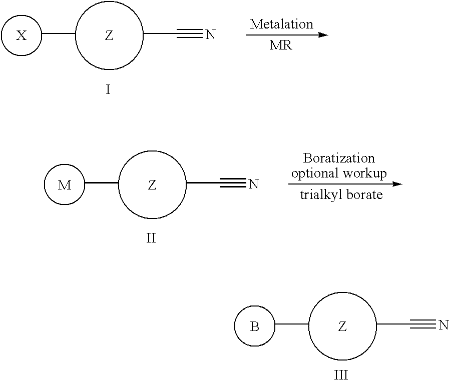
where X is H, Br or I,
MR is a metalating reagent, 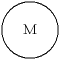
is a metal, optionally with further counterions and/or ligands,
and Z and 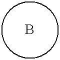
are each as defined in claim 1.

8. The process as claimed in claim 7, wherein the compound of the formula (III) is obtained from (I) in situ.

9. The process as claimed in claim 1, wherein the resulting aminocarbonylboronic acid of the formula (IV) is processed further without isolation.

10. A process for preparing boronic acids of the formula (III) functionalized by cyano groups by metalating nitrile compounds of the formula (I) with a metalating reagent MR and then reacting the metalated compound of the formula (II) with a trialkyl borate to give the compound of the formula (III) 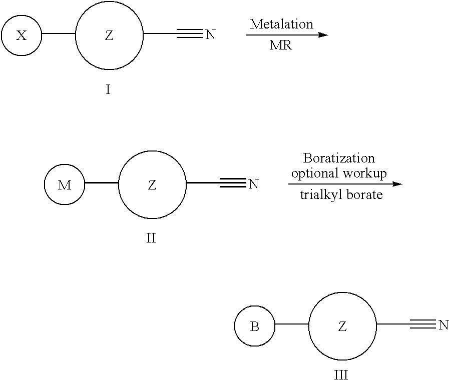
where X is H, Br or I 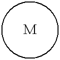
is a metal, optionally with further counterions and/or ligands, MR is a metalating reagent containing an alkali metal or alkaline earth metal or zinc, Z is an optionally substituted alkylene, heteroalkylene, alkylidene, heteroalkylidene, alkenylidene, heteroalkenylidene, alkynylidene, arylalkylene, heteroarylalkylene, arylheteroalkylene, heteroarylheteroalkylene, alkylheteroarylene, heteroalkylheteroarylene or alkylarylene radical, where the CN group is bonded to an aliphatic carbon atom, and 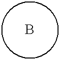
is a boronic acid, a boronic ester or a borate, or a boronic anhydride.

11. The process as claimed in claim 10, wherein the metalation is effected with metalating reagent selected from lithium organyls, lithium organyls in the presence of complexing agents or alkali metal alkoxides, alkali metal amides and silazides, Grignard compounds, magnesium diorganyls, triorganyl magnesates, magnesium dialkylamides, and the foregoing reagents in the presence of alkali metal salts and/or complexing agents, or metallic zinc.

12. The process as claimed in claim 6, wherein the resulting carboxyboronic acid of the formula (V) is processed further without isolation.

13. The process as claimed in claim 7, wherein the metalation is effected with metalating reagent selected from lithium organyls, lithium organyls in the presence of complexing agents or alkali metal alkoxides, alkali metal amides and silazides, Grignard compounds, magnesium diorganyls, triorganyl magnesates, magnesium dialkylamides, and the foregoing reagents in the presence of alkali metal salts and/or complexing agents, or metallic zinc.
